(19) United States
(12) Patent Application Publication
(10) Pub. No.: US 2021/0084223 A1
(43) Pub. Date: Mar. 18, 2021

(54) APPARATUS AND METHODS FOR CAMERA SELECTION IN A MULTI-CAMERA

(71) Applicant: SAMSUNG ELECTRONICS CO., LTD., Suwon-si (KR)

(72) Inventors: Gaurav KHANDELWAL, Bangalore (IN); Abhijit DEY, Bangalore (IN); Vedant PATEL, Bangalore (IN); Ashish Kumar SINGH, Bangalore (IN); Harisha HS, Bangalore (IN); Kiran NATARAJU, Bangalore (IN); Rajib BASU, Bangalore (IN); Praveen R. JADHAV, Bangalore (IN)

(73) Assignee: SAMSUNG ELECTRONICS CO., LTD., Suwon-si (KR)

(21) Appl. No.: 17/012,947

(22) Filed: Sep. 4, 2020

(30) Foreign Application Priority Data
Sep. 5, 2019 (IN) 201941035813
Jul. 21, 2020 (IN) 2019 41035813

(51) Int. Cl. H04N 5/232; G06K 9/32

(52) U.S. Cl. CPC H04N 5/23245; G06K 9/3233; H04N 5/232939; H04N 5/23222; H04N 5/23218

(57) ABSTRACT

A method performed by user equipment (UE) for selecting a camera among multi-camera includes receiving a user instruction indicative of capturing of a scene and detecting Time of Flight (TOF) sensor information relating to scene. The TOF sensor information pertains to details relating to depth of each pixel in an image and an IR image of the scene. The method includes determining depth information of the scene based on the TOF sensor information and is indicative of a ROI in the scene, information about at least one object in the scene, and a type of the scene. The method includes determining scene information based on the depth information including identification information of the at least one object in the scene and distance information to the UE from each object from among the at least one object. The method includes selecting a camera, from among a plurality of cameras based on the scene information.

### CROSS-REFERENCE TO RELATED APPLICATIONS

This application is based on and claims priority under 35 U.S.C. § 119 to Indian Provisional Patent Application No. 201941035813, filed on Sep. 5, 2019 in the Indian Patent Office, and to Indian Complete Patent Application No. 201941035813, filed on Jul. 21, 2020 in the Indian Patent Office, the disclosures of which are incorporated by reference herein in their entirety.

### BACKGROUND

### 1. Field

The disclosure relates to multi-camera User Equipment (UE) and more particularly, relates to systems and methods of selecting a suitable camera for capturing a scene using the multi-camera UE.

### 2. Description of Related Art

Nowadays, it is quite common for the smart communication devices to have multiple cameras. These cameras may be provided either at the rear or at the front or on both sides of the device. The user is required to explicitly select one of these cameras to capture a scene, based on his/her preference. Generally, when the user activates the camera to capture a scene, a preview of the scene is generated from the default camera. If the user is not satisfied with the default preview, the user can manually select a camera from among the multiple cameras to have a better picture of the scene.

FIG. 1 illustrates a related art example of a default preview 104 and another preview 106 of a user-selected camera for capturing a scene. As illustrated, when the user gives an input 102 to capture a scene, a preview 104 from the default camera of the UE is generated for the user. In case the user is not satisfied with the default preview, the user analyzes the scene and manually selects one of the other cameras to capture the scene. The selected camera then generates another preview 106 for capturing the scene. The selection of the camera is based upon the user's analysis of the scene, which may involve various factors for consideration, such as the landscape, objects in the field of view, and lighting conditions of the scene.

First of all, the user has to spend significant time in opening the default camera, analyzing the scene, and then selecting the camera of his/her preference. It would be more time-intensive when the user explores the previews of the multiple cameras to select the preferred preview, which usually is the case. Moreover, even after spending time in the selection of the camera, there exists a possibility that the quality of the capture is still not good. Also, the quality of the picture is totally dependent on the user's skill set. On the other hand, when the user proceeds with the default camera, it may lead to subpar capture quality and user experience.

There are some existing solutions where the UE generates the previews of all the available cameras for the user to select the preferred one. However, this involves unnecessary processing and the consequent unnecessary use of resources for generating multiple previews. Moreover, even in this case, the capturing of the scene is heavily dependent on the skill set of the user, which may sometimes lead to unclear and poor quality of the pictures.

### SUMMARY

This summary is provided to introduce a selection of concepts, in a simplified format, that are further described in the detailed description. This summary is neither intended to identify key or essential concepts of the disclosure and nor is it intended for determining the scope of the disclosure.

In accordance with an aspect of the disclosure, a method performed by user equipment (UE) for selecting a camera in a multi-camera includes receiving a first user instruction to capture a scene comprising at least one object; detecting time of flight (TOF) sensor information relating to the scene, wherein the TOF sensor information includes a depth of each pixel in a visible image of the scene and in an infrared (IR) image of the scene; determining depth information of the scene based on the TOF sensor information, wherein the depth information includes a region of interest (ROI) in the scene, information about the at least one object in the scene, and a type of the scene; determining scene information based on the depth information, wherein the scene information includes identification information of the at least one object in the scene and distance information to the UE from each object from among the at least one object; and selecting a camera, from among a plurality of cameras, for capturing the scene, based on the scene information.

The method may further include generating a preview for capturing the scene based on the selected camera.

The method may further include confirming an accuracy of the scene information based on the TOF sensor information.

The method may further include generating a score for each camera from among the plurality of cameras based on the scene information, wherein the score is indicative of a suitability of the respective camera for capturing the scene and selecting the camera with a highest score, from among the plurality of cameras, for capturing the scene.

The method may further include receiving a second user instruction to reject the preview generated based on the selected camera for capturing the scene; and receiving a third user instruction to select a different camera from among the plurality of cameras for generating a different preview for capturing the scene.

The plurality of cameras may include at least one from among a wide camera, a tele camera, an ultrawide camera, and a macro camera.

The scene information may include at least one from among a number of objects in the scene, a type of the scene, a type of each object from among the at least one object, a light condition, a priority level of each object from among the at least one object, and a focus point.

The method may further include, after receiving the first user instruction, capturing the scene with a default camera of the multi-camera to generate a first picture; selecting another camera of the multi-camera, from among the plurality of cameras, for capturing the scene based on the scene information; and capturing the scene with the other camera of the multi-camera to generate a second picture.

The multi-camera may include at least one from among a wide camera, a tele camera, an ultrawide camera, and a macro camera.

The scene information may include at least one from among a number of objects in the scene, a type of the scene, a type of each object from among the at least one object, a light condition, a priority level of each object from among the at least one object, and a focus point.

In accordance with an aspect of the disclosure, a user equipment (UE) for selecting a camera among multi-camera includes a receiving module configured to receive a first user instruction to capture to capture a scene including at least one object; and time of flight (TOF) sensor information, wherein the TOF sensor information includes a depth of each pixel in a visible image of the scene and in an infrared (IR) image of the scene; a determining module operably coupled to the receiving module and configured to determine depth information of the scene based on the TOF sensor information, wherein the depth information includes a region of interest (ROI) in the scene, information about the at least one object in the scene, and a type of the scene; and scene information based on the depth information, wherein the scene information includes identification information of the at least one object in the scene and a distance information to the UE from each object from among the at least one object; and a camera selection module operably coupled to the determining module and configured to select a camera, from among a plurality of cameras, for capturing the scene, based on the scene information.

The system may further include a generating module operably coupled to the camera selection module and configured to generate a preview for capturing the scene based on the selected camera.

The determining module may be further configured to confirm an accuracy of the scene information based on the TOF sensor information.

The system may further include a score generating module operably coupled to the camera selection module and configured to generate a score for each camera from among the plurality of cameras based on the scene information, wherein the score is indicative of a suitability of the respective camera for capturing the scene, wherein the camera selection module is further configured to select the camera with a highest score, from among the plurality of cameras, for capturing the scene.

The system may further include a receiving module operably coupled to the generating module and configured to receive a second user instruction to reject the preview generated based on the selected camera for capturing the scene; and receive a third user instruction to select a different camera from among the plurality of cameras for generating a different preview for capturing the scene.

The plurality of cameras may include at least one from among a wide camera, a tele camera, an ultrawide camera, and a macro camera.

The scene information may include at least one from among a number of objects in the scene, a type of the scene, a type of each object from among the at least one object, a light condition, a priority level of each object from among the at least one object, and a focus point.

The system may further include a capturing module operably coupled to the receiving module and configured to capture the scene with a default camera of the multi-camera to generate a first picture after receiving the first user instruction by the receiving module, wherein the camera selection module is further configured to select another camera of the multi-camera, from among the plurality of cameras, for capturing the scene based on the scene information, and wherein the capturing module is further configured to capture the scene with the other camera of the multi-camera to generate a second picture.

The multi-camera may include at least one from among a wide camera, a tele camera, an ultrawide camera, and a macro camera.

The scene information may include at least one from among a number of objects in the scene, a type of the scene, a type of each object from among the at least one object, a light condition, a priority level of each object from among the at least one object, and a focus point.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example image indicating the Manual Camera Switch, in accordance with related art;

FIG. 2 illustrates a block diagram of a system for selecting a camera in a multi-camera User Equipment (UE), according to an embodiment;

FIG. 3 illustrates a block diagram depicting selection of a camera in the multi-camera UE, according to an embodiment;

FIG. 4 illustrates another block diagram depicting selection of a camera in the multi-camera UE, according to an embodiment;

FIG. 5 illustrates a flowchart depicting a method of selecting a camera in the multi-camera UE, according to an embodiment;

FIG. 6A illustrates a use case depicting selection of a camera in the multi-camera UE for capturing a scene, according to related art;

FIG. 6B illustrates a use case depicting selection of a camera in the multi-camera UE for capturing a scene, according to an embodiment;

FIG. 7A illustrates a use case depicting selection of a camera in the multi-camera UE for capturing a scene, according to related art;

FIG. 7B illustrates a use case depicting selection of a camera in the multi-camera UE for capturing a scene, according to an embodiment;

FIG. 8A illustrates a use case depicting selection of a camera in the multi-camera UE for capturing a scene, according to related art;

FIG. 8B illustrates a use case depicting selection of a camera in the multi-camera UE for capturing a scene, according to an embodiment;

FIG. 9 illustrates a flowchart depicting a method of selecting a camera in the multi-camera UE, according to an embodiment;

FIG. 10 illustrates a use case depicting selection of a camera in the multi-camera UE for capturing a scene, according to an embodiment;

FIG. 11 illustrates another use case depicting selection of a camera in the multi-camera UE for capturing a scene, according to an embodiment; and

FIG. 12 illustrates yet another use case a use case depicting selection of a camera in the multi-camera UE for capturing a scene, according to an embodiment.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the disclosure. Furthermore, in terms of the construction of the device, one or more components of the device may have been represented in the drawings by conventional symbols, and the drawings may show only those specific details that are pertinent to understanding the embodiments of the disclosure so as not to obscure the drawings with details that will be readily apparent to those of ordinary skill in the art having benefit of the description herein.

### DETAILED DESCRIPTION

For the purpose of promoting an understanding of the principles of the disclosure, reference will now be made to the embodiment illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates. Unless otherwise defined, all technical and scientific terms used herein have the same meaning as commonly understood by one of ordinary skilled in the art to which this disclosure belongs. The system, methods, and examples provided herein are illustrative only and not intended to be limiting.

Embodiments of the disclosure will be described below in detail with reference to the accompanying drawings.

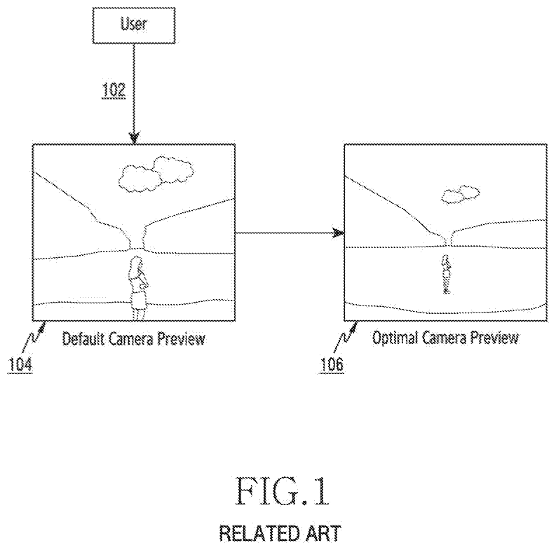

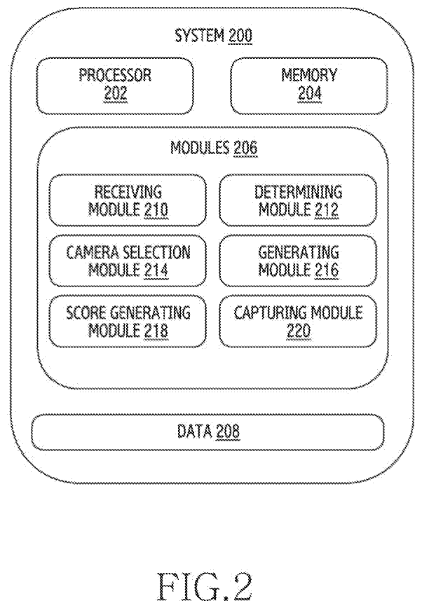

For the sake of clarity, the first digit of a reference numeral of each component of the disclosure is indicative of the Figure number, in which the corresponding component is shown. For example, reference numerals starting with digit “1” are shown at least in FIG. 1. Similarly, reference numerals starting with digit “2” are shown at least in FIG. 2.

FIG. 2 illustrates a block diagram of a system 200 for selecting a camera in a multi-camera UE, according to an embodiment. For the sake of readability, the multi-camera UE may interchangeably be referred to as the UE. The UE may include, but is not limited to, a smart phone, a tablet, and a laptop. The UE may also include, but is not limited to, an Ultra-wide camera, a Tele camera, a Wide camera, and a Macro camera.

In an embodiment, the system 200 may include, but is not limited to, a processor 202, a memory 204, modules 206, and data 208. The modules 206 and the memory 204 may be coupled to the processor 202. The processor 202 can be a single processing unit or a number of units, all of which could include multiple computing units. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 may be configured to fetch and execute computer-readable instructions and data stored in the memory 204.

The memory 204 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

The modules 206, amongst other things, include routines, programs, objects, components, data structures, etc., which perform particular tasks or implement data types. The modules 206 may also be implemented as, signal processor(s), state machine(s), logic circuitries, and/or any other device or component that manipulate signals based on operational instructions.

Further, the modules 206 can be implemented in hardware, instructions executed by a processing unit, or by a combination thereof. The processing unit executing the instructions can comprise a computer, a processor, such as the processor 202, a state machine, a logic array or any other suitable devices capable of processing instructions. The processing unit can be a general-purpose processor which executes instructions to cause the general-purpose processor to perform the required tasks or, the processing unit can be dedicated to perform the required functions. In an embodiment, the modules 206 may be machine-readable instructions (software) which, when executed by a processor/processing unit, perform any of the described functionalities.

In an implementation, the modules 206 may include a receiving module 210, a determining module 212, a camera selection module 214, a generating module 216, a score generating module 218, and a capturing module 220. The receiving module 210, the determining module 212, the camera selection module 214, the generating module 216, the score generating module 218, and the capturing module 220 may be in communication with each other. Further, the data 208 serves, amongst other things, as a repository for storing data processed, received, and generated by one or more of the modules 206.

In an embodiment, the receiving module 210 may be adapted to receive an input indicative of capturing of a scene. The input may be received, for example, by opening of a camera application in the UE. The receiving module 210 may further be adapted to receive Time of Flight (TOF) information from a TOF sensor. The TOF sensor information may be indicative of details relating to a depth of each pixel in an image (i.e., a visible image) of the scene and an Infrared (IR) image of the scene. In other words, the TOF sensor information may include the depth of each pixel in the image of the scene and in the IR image of the scene.

In an embodiment, the TOF sensor may be disposed in a TOF camera. The TOF camera uses infrared light (lasers invisible to human eyes) to determine depth-related information. The TOF sensor may be adapted to emit a light signal, which hits the subject and returns to the sensor. The time taken for the light signal to return is then measured to determine depth-mapping capabilities. In an embodiment, the receiving module 210 may be in communication with the determining module 212.

The determining module 212 may be adapted to determine depth information of the scene based on the TOF sensor information. The depth information is indicative of a Region of Interest (ROI) in the scene, at least one object present in the scene, and a category (i.e., type) of the scene. The objects present in the scene may include, but are not limited to, a house, a flower, kids, and a mountain. Similarly, the categories of the scene include, but are not limited to, an open scene, a closed scene, a nightclub scene, sky, and a waterfall.

Further, the determining module 212 may be adapted to determine scene information based on the depth information. The scene information may include, but is not limited to, details relating to identification of at least one object in the scene and a distance of each object in the scene from the UE. In an embodiment, the scene information may further include, but is not limited to, details relating to at least one of a number of objects, a type of scene, a type of each object in the scene, light condition, a priority level of each object in the scene, or a focus point. In an embodiment, the determining module 212 may be adapted to confirm an accuracy of the scene information based on the TOF sensor information relating to the depth of each pixel in the image of the scene. In an embodiment, the determining module 212 may be in communication with the camera selection module 214.

The camera selection module 214 may be adapted to select a camera, from among a plurality of cameras, for capturing the scene, based on the scene information. In an embodiment, the camera selection module 214 may be in communication with the generating module 216. The generating module 216 may be adapted to generate a preview for capturing the scene based on the selected camera.

In an embodiment, the camera selection module 214 may be in communication with the score generating module 218. The score generating module 218 may be adapted to generate a score for each camera based on the scene information. The score is indicative of the suitability of a camera for capturing the scene. Based on the score generated by the score generating module 218, the camera selection module 214 may be adapted to select the camera with the highest score, from among the plurality of cameras, for capturing the scene.

In an example, the score may be allocated to the cameras on a scale of 0-100. For example, based on the scene information, the score generation module 218 may generate a score of 70 for the tele camera and a score of 80 for the macro camera. In such an example, the camera selection module 214 may select the macro camera for capturing the scene.

In an embodiment, the user captures the scene by selecting a camera in a multi-camera User Equipment (UE), with the user intervention. Once the preview is generated by the generating module 216 for capturing the scene based on the selected camera, the user may reject the preview generated by the selected camera for capturing the scene. In such an embodiment, the receiving module 210 may receive a second user instruction indicative of rejecting the preview generated by the selected camera for capturing the scene. Subsequently, the receiving module 210 may receive a third user instruction from the user. The third user instruction may be indicative of selecting one of the cameras from among the plurality of cameras. Accordingly, the generation module 216 may generate the preview for capturing the scene.

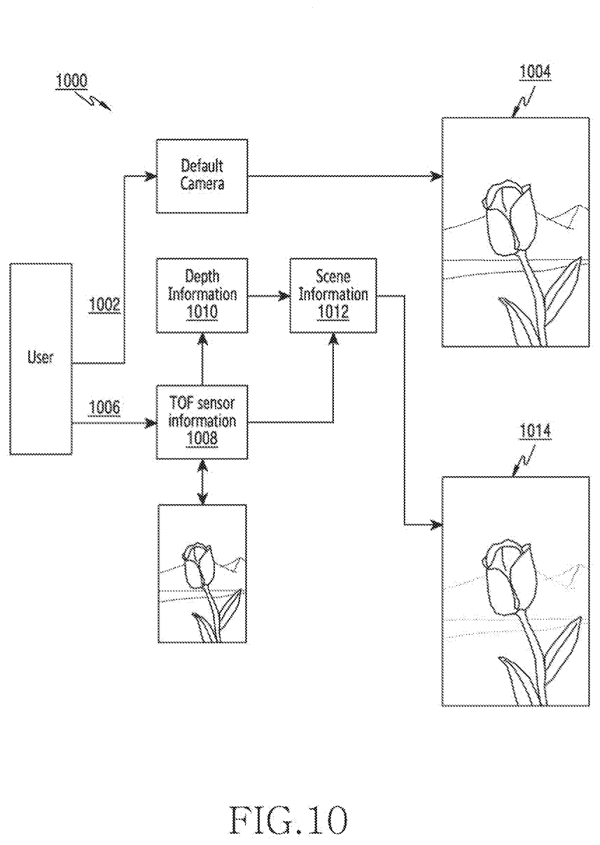

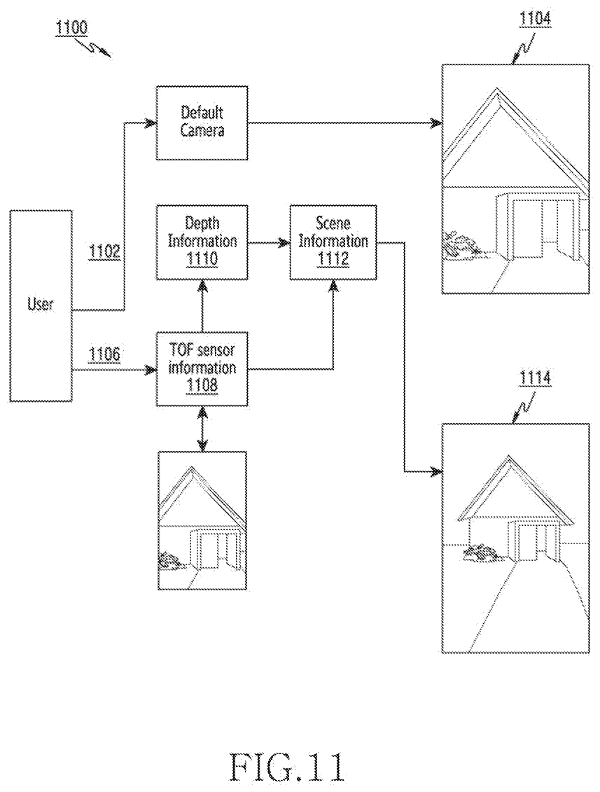

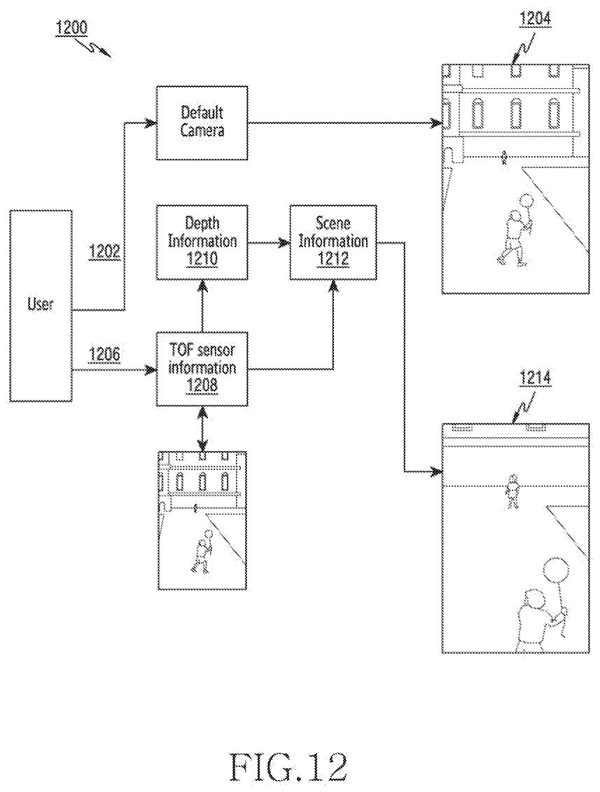

In an embodiment, the capturing module 220 may be adapted to capture the scene with a default camera of the UE to generate a first picture. Further, the capturing module 220 may be adapted to capture the scene with another camera of the UE to generate a second picture, where the other camera is selected from among the plurality of cameras based on the scene information. This embodiment is explained in detail in the description of FIG. 10, FIG. 11, FIG. 12, and FIG. 13.

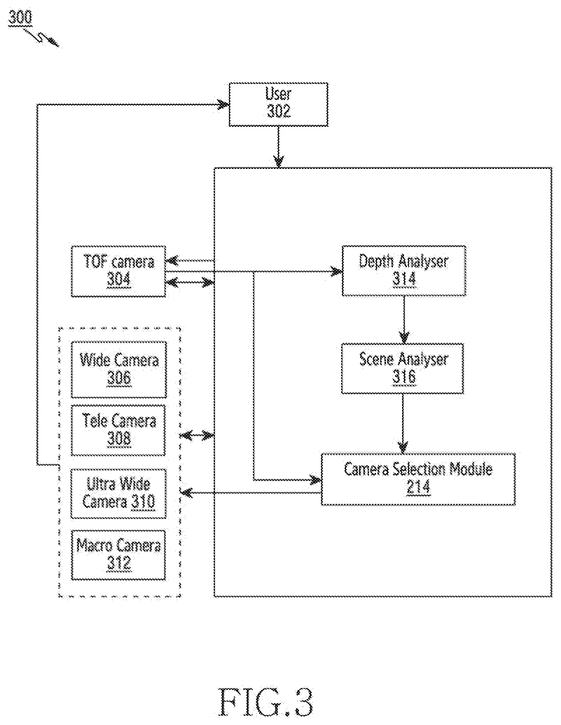

FIG. 3 illustrates a block diagram 300 depicting a system for selection of a camera in the multi-camera UE, according to an embodiment. For the sake of brevity, features of the system 200 that are already explained in the description of FIG. 2 are not explained in the description of FIG. 3.

A user 302 provides an input to the system 200 for capturing the image. Upon receiving the input, the system 200 selects the TOF camera 304 to receive the TOF sensor information. The TOF sensor information may be provided to a depth analyzer 314 of the system 200 to determine the depth information of the scene. Further, the depth information from the depth analyzer 314 may be provided to a scene analyzer 316. The scene analyzer 316 may be adapted to determine the scene information. In an embodiment, the depth analyzer 314 and the scene analyzer 316 may be a part of the determining module 212.

The scene information from the scene analyzer 316 may be provided to the camera selection module 214. The camera selection module 214 may be adapted to select the camera, from among the plurality of cameras, for capturing the scene, based on the scene information. Once the camera is selected, the preview for capturing the scene based on the selected camera is generated at for the user 302.

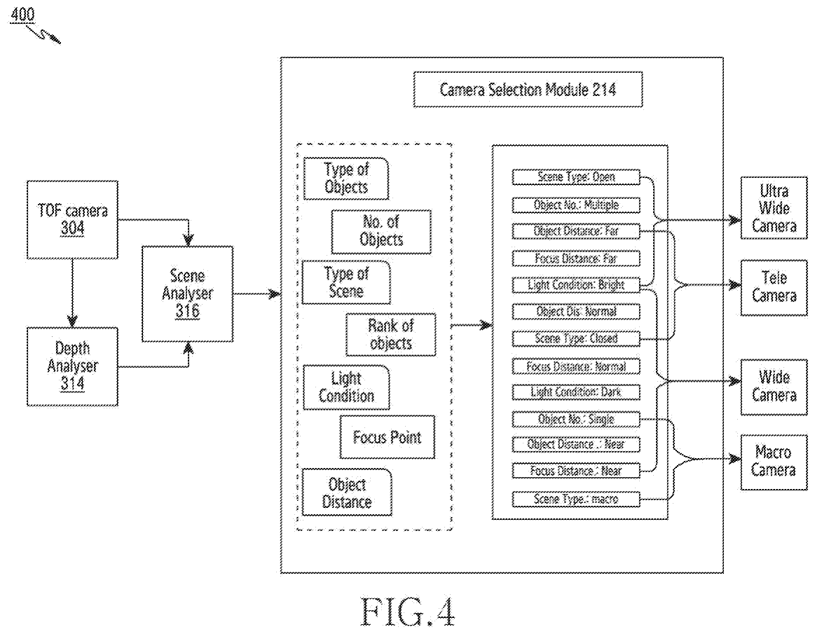

FIG. 4 illustrates another block diagram 400 depicting a system for selection of a camera in the multi-camera UE, according to an embodiment of the present disclosure. According to the embodiment, the camera selection module 214 analyses the information received from the scene analyzer 316. The information received from the scene analyzer 316 includes but is not limited to a type of one or more objects in the scene, a number of objects in the scene, a type of scene, a rank of one or more objects, a light condition while capturing the scene, a focus point and distance of the one or more objects present in the scene from the camera.

The camera selection module 214 analyzes said information to select the camera suitable to capture the scene. The camera selection module 214 first selects the one or more objects present in the scene and arranges them based upon the priority of the object in the scene and type of the object. The information about the priority and type of the object may be predetermined in the camera selection module 214. Further, the camera selection module 214 generates the score for each camera of the plurality of cameras based on the scene information. The score is indicative of the suitability of a camera for capturing the scene. The camera with the highest score is selected from among the plurality of cameras, for capturing the scene. In said embodiment, once the objects present in the scene are arranged by priority and/or type, various camera options may be available for capturing the scene. If more than one camera is available to capture the scene based upon the scene information, the camera with the highest score will be selected by the camera selection module 214 for capturing the scene.

For example, based upon the scene type: open, object number: multiple, object distance as far, focus distance as far and light condition as bright, an Ultra-Wide camera may be selected. Upon the object distance as far, focus distance as far and light condition as bright, a Tele camera may also be determined to be available. In this case, the camera with the highest score is selected from among the plurality of cameras, for capturing the scene by the camera selection module 214.

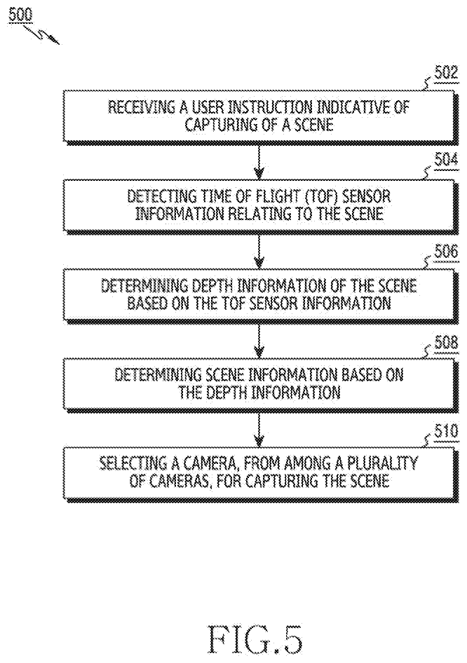

FIG. 5 illustrates a flowchart depicting a method 500 of selecting a camera in a multi-camera UE, according to an embodiment. In an embodiment, the method 500 may be a computer-implemented method 500. In an embodiment, the method 500 may be executed by the processor 202. Further, for the sake of brevity, features of the present disclosure that are explained in detail in the description of FIG. 2, FIG. 3, and FIG. 4 not explained in detail in the description of FIG. 5.

At a block 502, the method 500 includes receiving a user instruction indicative of capturing of a scene. In an embodiment, the receiving module 210 of the system 200 may receive the user instruction indicative of capturing of a scene.

At a block 504, the method 500 includes detecting the TOF sensor information relating to the scene. The TOF sensor information is indicative of details relating to depth of each pixel in an image of the scene and the IR image of the scene. In an embodiment, the receiving module 210 may detect the TOF sensor information.

At a block 506, the method 500 includes determining the depth information of the scene based on the TOF sensor information. The depth information is indicative of the ROI in the scene, the object present in the scene, and the category (i.e., type) of the scene. In an embodiment, the determining module 212 may perform the determination.

At a block 508, the method 500 includes determining the scene information based on the depth information. The scene information includes details relating to identification of at least one object in the scene and a distance of each object from the UE. In an embodiment, the determining module 212 may perform the determination.

At a block 510, the method 500 includes selecting a camera, from among the plurality of cameras, for capturing the scene, based on the scene information. In an embodiment, the camera selection module 214 may perform the selection of the camera, from among the plurality of cameras for capturing the scene.

In an embodiment, the method 500 may include generating the preview for capturing the scene based on the selected camera. In an embodiment, the generating module 216 may generate the preview.

In an embodiment, the method 500 may include confirming the accuracy of the scene information based on the TOF sensor information relating to the depth of each pixel in the image of the scene. In an embodiment, the determining module 212 may perform the confirmation of the accuracy of the scene information.

In an embodiment, the method 500 may include generating the score for each camera based on the scene information. The score is indicative of the suitability of a camera for capturing the scene. In an embodiment the score generating module 218 may generate the score for each camera based on the scene information. The method includes selecting the camera with the highest score, from among the plurality of cameras, for capturing the scene. In an embodiment, the camera selection module 214 may select the camera with the highest score for capturing the scene.

In an embodiment, the method 500 may include receiving the second user instruction indicative of rejecting the preview generated by the selected camera for capturing the scene. In said embodiment, the method 500 may also include receiving the third user instruction indicative of selecting one of the cameras from among the plurality of cameras for generating another preview for capturing the scene. In an embodiment, the receiving module 210 may generate the preview for capturing the scene.

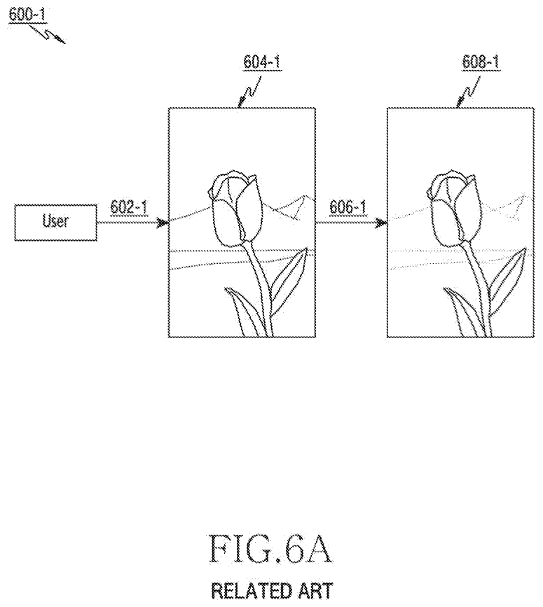

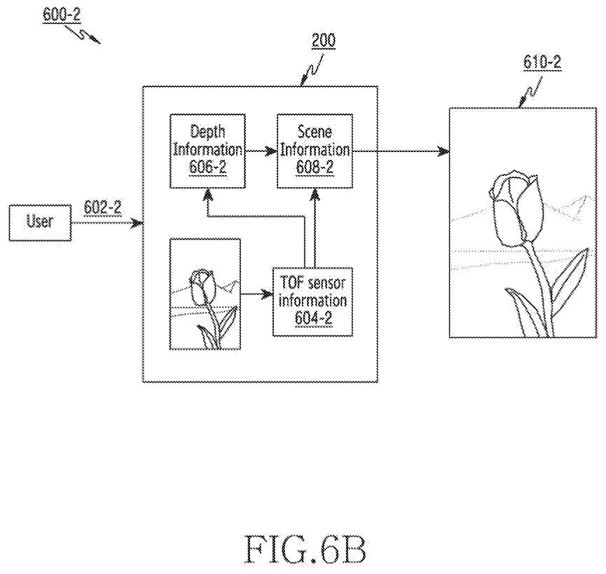

FIG. 6A illustrates a use case depicting selection of a camera in the multi-camera UE for capturing a scene, according to related art. The user provides an input 602-1 to capture a scene from the UE. Once the input is received from the user, the preview 604-1 is generated for the user from the default camera of the UE. In said example, the default camera is a Wide Camera. After the preview is generated, the user analyzes the scene and selects the suitable camera at 606-1 from among the multiple cameras in the UE. In said example, the user after analyzing the scene selects Macro camera for capturing the scene. The preview 608-1 is generated for the user from the suitable camera (in this case, the Macro camera) selected at 606-1.

FIG. 6B illustrates a use case depicting selection of a camera in the multi-camera UE for capturing a scene, according to an embodiment. The user provides an input 602-2 to the UE for capturing a scene. Once the input is received by the system 200, at a block 604-2, the TOF sensor information is determined. At a block 606-2, the depth information is determined based on the TOF sensor information. At a block 608-2, the scene information is determined based on the depth information of the scene. In an embodiment, the depth information of the scene along with the TOF sensor information is used to determine the scene information at 608-2.

In an example, the type of scene is Macro, the type of object is flower, and the object distance is near. The system 604-2 selects a camera, from among the plurality of cameras, for capturing the scene, based on said scene information. The preview 610-2 is generated for capturing the scene based on the selected camera. In said example, the system 200 after analyzing the scene selects Macro camera for capturing the scene.

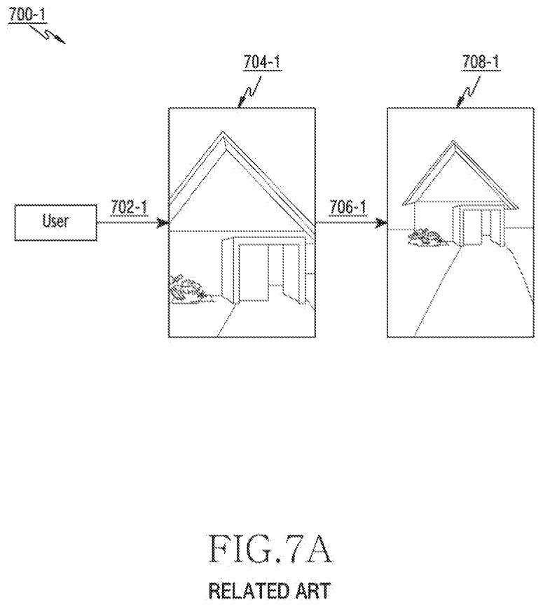

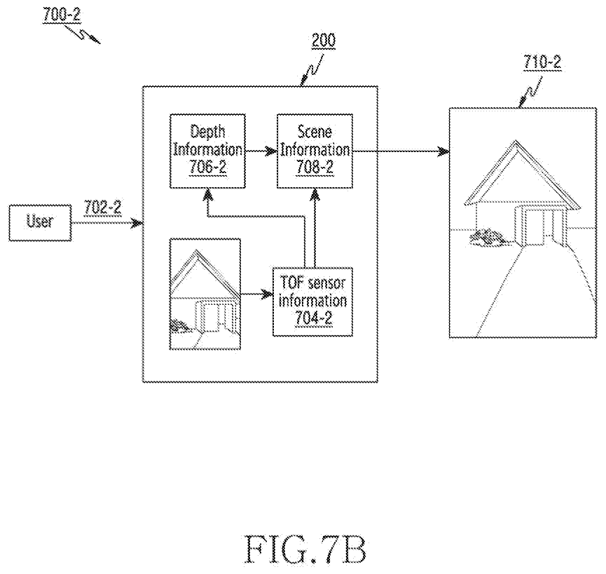

FIG. 7A illustrates a use case depicting selection of a camera in the multi-camera UE for capturing a scene, according to related art. The user provides an input 702-1 to capture a scene from the UE. Once the input is received from the user, the preview 704-1 is generated for the user from the default camera of the UE. In said example, the default camera is a Wide Camera. After the preview is generated, the user analyzes the scene and selects the suitable camera at 706-1 from among the multiple cameras in the UE. In said example, the user after analyzing the scene selects the Ultra Wide camera for capturing the scene. The preview 708-1 is generated for the user from the suitable camera (in this case, the Ultra Wide camera) selected at 706-1.

FIG. 7B illustrates a use case depicting selection of a camera in the multi-camera UE for capturing a scene, according to an embodiment. The user provides input 702-2 to the UE for capturing a scene. Once the input is received by the system 200, at block 704-2, the TOF sensor information is determined. At a block 706-2, the depth information is determined based on the TOF sensor information. At a block 708-2, the scene information is determined based on the depth information of the scene. In an embodiment, the depth information of the scene along with the TOF sensor information is used to determine the scene information at 708-2.

In an example, the type of scene is Open, type of object is house, and object distance is away, etc. The system 200 selects a camera, from among the plurality of cameras, for capturing the scene, based on the scene information. The preview 710-2 is generated for capturing the scene based on the selected camera. In said example, the system 200 after analyzing the scene information selects Ultra Wide camera for capturing the scene.

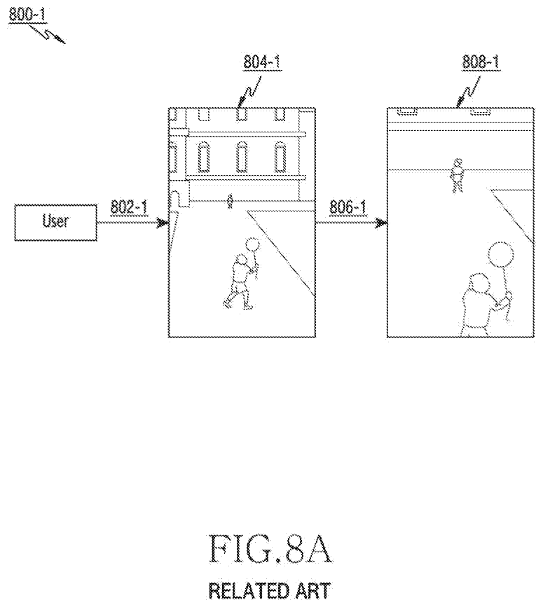

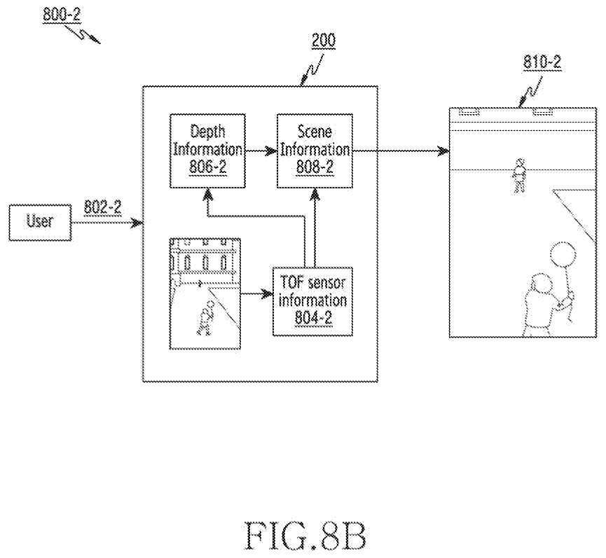

FIG. 8A illustrates a use case depicting selection of a camera in the multi-camera UE for capturing a scene, according to related art. The user provides an input 802-1 to capture a scene from a UE. Once the input is received by the user, the preview 804-1 is generated for the user from the default camera of the UE. In said example, the default camera is a Wide Camera. After the preview is generated, the user analyzes the scene and selects the suitable camera at 806-1 from among the multiple cameras in the UE. In said example, the user after analyzing the scene selects Tele camera for capturing the scene. The preview 808-1 is generated for the user from the suitable camera (in this case, the Tele camera) selected at 806-1.

FIG. 8B illustrates a use case depicting selection of a camera in the multi-camera UE for capturing a scene, according to an embodiment. The user provides input 802-2 to the UE for capturing a scene. Once the input is received by the system 200, at block 804-2, the TOF sensor information is determined. At a block 806-2, the depth information is determined based on the TOF sensor information. At a block 808-2, the scene information is determined based on the depth information of the scene. In an embodiment, the depth information of the scene along with the TOF sensor information is used to determine the scene information at 808-2.

In an example, the type of scene is closed, type of object is human, and object distance is away, etc. The system 200 selects a camera, from among the plurality of cameras, for capturing the scene, based on the scene information. The preview 810-2 is generated for capturing the scene based on the selected camera. In said example, the system 200 after analyzing the scene information selects Tele camera for capturing the scene.

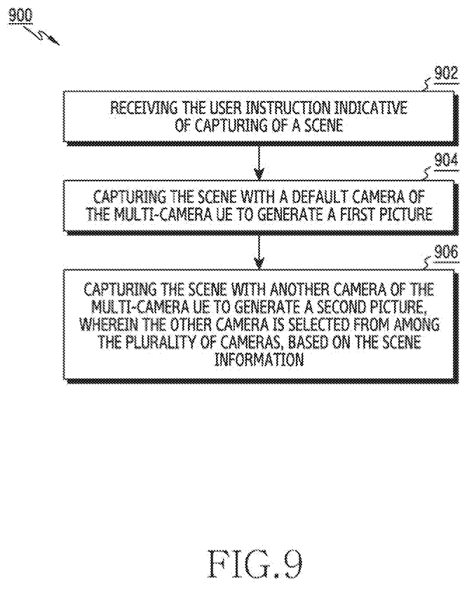

FIG. 9 illustrates a flowchart depicting a method 900 of selecting a camera in a multi-camera UE, according to an embodiment. In an embodiment, the method 900 may be a computer-implemented method 900. In an embodiment, the method 900 may be executed by the processor 202. Further, for the sake of brevity, features of the present disclosure that are explained in detail in the description of FIG. 2-FIG. 8 are not explained in detail in the description of FIG. 9.

At a block 902, the method 900 includes receiving the user instruction indicative of capturing of a scene. In an embodiment, the receiving module 210 may receive the user instruction indicative of capturing of a scene.

At a block 904, the method 900 includes capturing the scene with the default camera of the multi-camera UE to generate a first picture.

At a block 906, the method 900 includes capturing the scene with another camera of the multi-camera UE to generate a second picture. The other camera is selected from among the plurality of cameras, based on the scene information. In an embodiment, the capturing module 220 in communication with the receiving module 210 may perform the capturing of the scene.

FIG. 10 illustrates a use case depicting selection of a camera in the multi-camera UE for capturing a scene, according to an embodiment. The user provides an input 1002 to the UE for capturing a scene. Once the input is received by the system 200, the scene is captured with a default camera of the multi-camera UE at a block 1004 to generate the first picture of the scene. In said example, the default camera is a Wide Camera. Further, the user provides an input 1006 to the system 200 for capturing the second picture of the scene. At a block 1008, the TOF sensor information is determined. At a block 1010, the depth information of the scene is determined. At a block 1012, the scene information is determined based on the depth information of the scene. In an embodiment, the depth information of the scene along with the TOF sensor information is used to determine the scene information at a block 1012.

In an example, the type of scene is Open, type of object is house, and object distance is away. The system 200 selects a camera, from among the plurality of cameras, for capturing the scene, based on said scene information. The second picture is generated for capturing the scene based on the selected camera at a block 1014. In said example, the system 200 after analyzing the scene selects Macro camera for capturing the scene.

FIG. 11 illustrates a use case depicting selection of a camera in the multi-camera UE for capturing a scene, according to an embodiment. The user provides an input 1102 to the UE for capturing a scene. Once the input is received by the system 200, at a block 1104, the scene is captured with a default camera of the multi-camera UE to generate the first picture of the scene. In said example, the default camera is a Wide Camera. Further, the user provides an input 1106 to the system 200 for capturing the second picture of the scene. At a block 1108, the TOF sensor information is determined. At a block 1110, the depth information of the scene is determined. At a block 1112, the scene information is determined based on the depth information of the scene. In an embodiment, the depth information of the scene along with the TOF sensor information is used to determine the scene information at a block 1112.

In an example, the type of scene type of scene is Macro, type of object is flower, and object distance is near. The system 200 selects a camera, from among the plurality of cameras, for capturing the scene, based on said scene information. The second picture is generated for capturing the scene based on the selected camera at block 1114. In said example, the system 200 after analyzing the scene selects Ultra-Wide camera for capturing the scene.

FIG. 12 illustrates a use case depicting selection of a camera in the multi-camera UE for capturing a scene, according to an embodiment. The user provides an input 1202 to the UE for capturing a scene. Once the input is received by the system 200, at a block 1204, the scene is captured with a default camera of the multi-camera UE to generate the first picture of the scene. In said example, the default camera is a Wide Camera. Further, user provides an input 1206 to the system 200 for capturing the second picture of the scene. At a block 1208, the TOF sensor information is determined. At a block 1210, the depth information of the scene is determined. At a block 1212, the scene information is determined based on the depth information of the scene. In an embodiment, the depth information of the scene along with the TOF sensor information is used to determine the scene information at a block 1212.

In an example, the type of scene is closed, type of object is human, and object distance is away, etc. The system 200 selects a camera, from among the plurality of cameras, for capturing the scene, based on said scene information. The second picture is generated for capturing the scene based on the selected camera at block 1214. In said example, the system 200 after analyzing the scene selects Tele camera for capturing the scene.

The disclosure provides a depth-based camera selection feature where the dependency on the user to select the camera is reduced significantly. The disclosure allows users to capture images faster without having to analyze the scene and manually selecting the optimal camera, saving their time and effort. Further, the camera selection according to the proposed solution helps to ensure that the images captured in various scenes have the best quality possible with the available sensor capabilities.

As the present disclosure provides the methods 500, 900 and the system 200 to select the suitable camera to capture the scene using the TOF sensor information, the depth information, and the scene information, the need for RGB data is eliminated. The camera selection is performed before any RGB data is captured from any of the cameras in the multi camera UE. Thus, the camera is selected before the preview of the scene to be captured is visible to the user. As the suitable camera is directly opened to capture the scene instead of the default camera, the user is provided with better capture quality and better usage experience as the user is not selecting the suitable camera to capture the scene. This also leads to saving time of the user in terms of opening the default camera and analyzing the scene.

Further, embodiments give the flexibility to the user, to further select one of the cameras manually, after analyzing the preview generated by the selected camera according to the proposed solution.

The disclosure provides methods and systems to select the suitable camera to capture the scene using TOF sensor information. There are multiple advantages of using TOF sensor-based determination when compared to traditional RGB sensor-based scene analysis. The advantages of using TOF sensor include independency on the light condition. The TOF sensors are not dependent on the light condition of the scene to provide details about the scene. However, the RGB sensors are heavily dependent on the light condition of the scene to provide details about it. Thus, in Low Light Conditions, TOF sensor will provide better results when compared to an RGB sensor. The advantage of using TOF sensor further includes depth accuracy. One of the major factors for scene analysis using determination based upon the TOF sensor, utilized in the disclosure is depth of the scene. The RGB sensors are unable to accurately provide the depth information of the scene whereas TOF sensors are able to accurately provide the depth information of the scene. Further, the TOF sensor does not require tuning to provide proper frames and therefore provides better performance than the RGB sensor. Further, the TOF sensor consumes less power when compared to RGB sensor.

Further, using of the TOF sensor in the disclosure to determine the depth information of the scene is advantageous over the conventional solutions to obtain the depth information regarding the scene to be captured. For example, in stereo vision camera, the camera setup requires multiple RGB sensors to provide depth data, which is costly, consumes extra power, and requires extra processing when compared to the TOF sensor. For example, the ML based Algorithms used to obtain the depth information regarding the scene to be captured depend highly on the image quality and do not provide accurate depth data when compared to the TOF sensor. For example, the stats-based algorithms used to obtain the depth information regarding the scene to be captured depend highly on the system and sensor capabilities and do not provide accurate depth data when compared to a TOF sensor.

While specific language has been used in the disclosure, any apparent limitations arising on account thereto, are not intended. As would be apparent to a person in the art, various working modifications may be made to the systems and methods as taught herein. The drawings and the foregoing description give examples of embodiments. Those skilled in the art will appreciate that one or more of the described elements may well be combined into a single functional element. Alternatively, certain elements may be split into multiple functional elements. Elements from any one embodiment may be added to any other embodiment.

What is claimed is:

1. A method performed by user equipment (UE) for selecting a camera among multi-camera, the method comprising:
receiving a first user instruction to capture a scene comprising at least one object;
detecting time of flight (TOF) sensor information relating to the scene, wherein the TOF sensor information comprises a depth of each pixel in a visible image of the scene and in an infrared (IR) image of the scene;
determining depth information of the scene based on the TOF sensor information, wherein the depth information comprises a region of interest (ROI) in the scene, information about the at least one object in the scene, and a type of the scene;
determining scene information based on the depth information, wherein the scene information comprises identification information of the at least one object in the scene and distance information to the UE from each object from among the at least one object; and
selecting a camera, from among a plurality of cameras, for capturing the scene, based on the scene information.

2. The method of claim 1, further comprising generating a preview for capturing the scene based on the selected camera.

3. The method of claim 1, further comprising confirming an accuracy of the scene information based on the TOF sensor information.

4. The method of claim 1, further comprising:
generating a score for each camera from among the plurality of cameras based on the scene information, wherein the score is indicative of a suitability of the respective camera for capturing the scene; and
selecting the camera with a highest score, from among the plurality of cameras, for capturing the scene.

5. The method of claim 2, further comprising:
receiving a second user instruction to reject the preview generated based on the selected camera for capturing the scene; and
receiving a third user instruction to select a different camera from among the plurality of cameras for generating a different preview for capturing the scene.

6. The method of claim 1, wherein the plurality of cameras comprises at least one from among a wide camera, a tele camera, an ultrawide camera, and a macro camera.

7. The method of claim 1, wherein the scene information comprises at least one from among a number of objects in the scene, a type of the scene, a type of each object from among the at least one object, a light condition, a priority level of each object from among the at least one object, and a focus point.

8. The method of claim 1, further comprising:
after receiving the first user instruction, capturing the scene with a default camera of the multi-camera to generate a first picture;
selecting another camera of the multi-camera, from among the plurality of cameras, for capturing the scene based on the scene information; and
capturing the scene with the other camera of the multi-camera UE to generate a second picture.

9. The method of claim 8, wherein the multi-camera comprises at least one from among a wide camera, a tele camera, an ultrawide camera, and a macro camera.

10. The method of claim 8, wherein the scene information comprises at least one from among a number of objects in the scene, a type of the scene, a type of each object from among the at least one object, a light condition, a priority level of each object from among the at least one object, and a focus point.

11. A user equipment (UE) for selecting a camera among multi-camera, the UE comprising:
a receiving module configured to receive:
a first user instruction to capture a scene comprising at least one object; and
time of flight (TOF) sensor information relating to the scene, wherein the TOF sensor information comprises a depth of each pixel in a visible image of the scene and in an infrared (IR) image of the scene;
a determining module operably coupled to the receiving module and configured to determine:
depth information of the scene based on the TOF sensor information, wherein the depth information comprises a region of interest (ROI) in the scene, information about the at least one object in the scene, and a type of the scene; and
scene information based on the depth information, wherein the scene information comprises identification information of the at least one object in the scene and distance information to the UE from each object from among the at least one object; and
a camera selection module operably coupled to the determining module and configured to select a camera, from among a plurality of cameras, for capturing the scene, based on the scene information.

12. The UE of claim 11, further comprising a generating module operably coupled to the camera selection module and configured to generate a preview for capturing the scene based on the selected camera.

13. The UE of claim 11, wherein the determining module is further configured to confirm an accuracy of the scene information based on the TOF sensor information.

14. The UE of claim 11, further comprising:
a score generating module operably coupled to the camera selection module and configured to generate a score for each camera from among the plurality of cameras based on the scene information, wherein the score is indicative of a suitability of the respective camera for capturing the scene,
wherein the camera selection module is further configured to select the camera with a highest score, from among the plurality of cameras, for capturing the scene.

15. The UE of claim 12, further comprising a receiving module operably coupled to the generating module and configured to:
receive a second user instruction to reject the preview generated based on the selected camera for capturing the scene; and
receive a third user instruction to select a different camera from among the plurality of cameras for generating a different preview for capturing the scene.

16. The UE of claim 11, wherein the plurality of cameras comprises at least one from among a wide camera, a tele camera, an ultrawide camera, and a macro camera.

17. The UE of claim 11, wherein the scene information comprises at least one from among a number of objects in the scene, a type of the scene, a type of each object from among the at least one object, a light condition, a priority level of each object from among the at least one object, and a focus point.

18. The UE of claim 11, further comprising:
a capturing module operably coupled to the receiving module and configured to capture the scene with a default camera of the multi-camera to generate a first picture after receiving the first user instruction by the receiving module; and,
wherein the camera selection module is further configured to select another camera of the multi-camera, from among the plurality of cameras, for capturing the scene based on the scene information, and
wherein the capturing module is further configured to capture the scene with the other camera of the multi-camera to generate a second picture.

19. The UE of claim 18, wherein the multi-camera comprises at least one from among a wide camera, a tele camera, an ultrawide camera, and a macro camera.

20. The UE of claim 18, wherein the scene information comprises at least one from among a number of objects in the scene, a type of the scene, a type of each object from among the at least one object, a light condition, a priority level of each object from among the at least one object, and a focus point.
